(19) United States
(12) Patent Application Publication
(10) Pub. No.: US 2007/0143308 A1
(43) Pub. Date: Jun. 21, 2007

(54) User-friendliness in switching a picture to be displayed

(75) Inventors: Takaharu Takayama, Kagoshima-shi (JP); Shinji Ehara, Bedpu-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/642,317

(22) Filed: Dec. 19, 2006

(30) Foreign Application Priority Data
Dec. 19, 2005 (JP) 2005-365338

(51) Int. Cl. G06F 17/30

(52) U.S. Cl. 707/10

(57) ABSTRACT

A network device comprises a Web service provider. In order to cause a client having a function as a Web browser in a network to display a series of multiple pictures, the Web service provider sends the client in response to a request from the client a markup language file described in a predetermined markup language. The markup language file includes as elements thereof a plurality of layers corresponding respectively to the series of multiple pictures. The layer has a visibility attribute that defines whether or not the layer will be displayed on the client. The Web service provider includes a Web program generator that generates a Web program that operates on the client and appends the Web program to the markup language file. The Web program causes the client to implement a first function whereby the visibility attributes of the plurality of layers are modified to switch the picture displayed on the client without communicating with the Web service provider.

### CROSS REFERENCE TO RELATED APPLICATIONS

The present application claims the priority based on Japanese Patent Application No. 2005-365338 filed on Dec. 19, 2005, the disclosure of which is hereby incorporated herein by reference in its entirety.

### BACKGROUND

1. Technical Field

The present invention relates to a technology for improving user-friendliness in switching a picture to be displayed among a series of multiple pictures, in a client that functions as a Web browser on a network.

2. Description of the Related Art

Technologies for use in network systems equipped with a printer that functions as a Web server and a client that functions as a Web browser, for enabling a predetermined picture to be displayed on a client, are known (see JP2004-705721A, for example). In such a network system, display of the predetermined picture on a client is achieved by having the printer send to the client on the network a markup language file (e.g. an HTML file) representing the predetermined picture.

Meanwhile, functions known as wizards are widely used to simplify user-directed operations relating to tasks such as installation of software and setting up network environments. A wizard is a function that sequentially displays a series of multiple pictures which allow the user to carry out task instructions in a dialog format.

In conventional network systems, a wizard function is accomplished through transfer between the Web server and a client of markup language files that correspond to each of the multiple pictures making up a series. That is, in each instance switching between display pictures generates communication for the purpose of requesting the markup language file that corresponds to the next picture to follow the switch, and for the purpose of responding to the request. Consequently, more time is needed for the process of switching a picture, and user-friendliness suffers as a result.

This sort of problem is one that is common to instances of switching a picture to be displayed among a series of multiple pictures, in clients that function as Web browsers on a network.

### SUMMARY

An object of the present invention is to provide a technology that enables user-friendliness to be improved during switching a picture to be displayed among a series of multiple pictures, in a client that functions as a Web browser on a network.

In one aspect of the present invention, there is provided a network device. The network device comprises a Web service provider. In order to cause a client having a function as a Web browser in a network to display a series of multiple pictures, the Web service provider sends the client in response to a request from the client a markup language file described in a predetermined markup language. The markup language file includes as elements thereof a plurality of layers corresponding respectively to the series of multiple pictures. The layer has a visibility attribute that defines whether or not the layer will be displayed on the client. The Web service provider includes a Web program generator that generates a Web program that operates on the client and appends the Web program to the markup language file. The Web program causes the client to implement a first function whereby the visibility attributes of the plurality of layers are modified to switch the picture displayed on the client without communicating with the Web service provider.

This network device comprises a Web service provider for sending, in response to a request from a client that functions as a Web browser on a network, a markup language file that contains as elements a plurality of layers corresponding respectively to the series of multiple pictures. The Web service provider includes a Web program generator for generating and appending to the markup language file a Web program for causing the client to implement a first function whereby the visibility attributes of the plurality of layers are modified to switch the picture displayed on the client, without communicating with the Web service provider. Consequently, switching the picture to be displayed among the series of multiple pictures on the client can be achieved by means of modifying the visibility attributes of the plurality of layers, without the need for communication between the network device and the client in association with switching pictures. Accordingly, with this network device the display picture switching process on the client can be accelerated, and user-friendliness can be improved. The term “Web program” as used herein represents any script or any program similar to script.

The present invention can be realized in various aspects. For example, the present invention can be realized in aspects such as a network device, a network system, server device, printing device, service providing method and device, image display method and device, a computer program for effecting the functions of such a method or device, a recording medium for recording such a computer program, and data signal in which such a computer program is carried on the carrier wave.

These and other objects, features, aspects, and advantages of the present invention will become more apparent from the following detailed description of the preferred embodiments with the accompanying drawings.

### BRIEF DESCRIPTION OF THE DRAWINGS

FIG. 1 is a block diagram showing schematically the configuration of a network system in the embodiment of the invention;

FIG. 2 is a flowchart showing the flows of the network setting process in the network system 10 of the embodiment;

FIG. 3 is a diagram showing an example of the printer top page;

FIG. 4 is a diagram showing in a conceptual fashion the network setting HTML file used in the embodiment;

FIG. 5 is a flowchart showing the flows of the wizard display process in the network system 10 of the embodiment;

FIG. 6 is a diagram showing an example of display pictures in the wizard display process; and

FIG. 7 is a block diagram showing schematically the configuration of a network system in the variation.

### DESCRIPTION OF THE PREFERRED EMBODIMENT

Next, aspects of the present invention will be described in the following order on the basis of embodiments:
A. Embodiment
B. Variations

### A. Embodiment

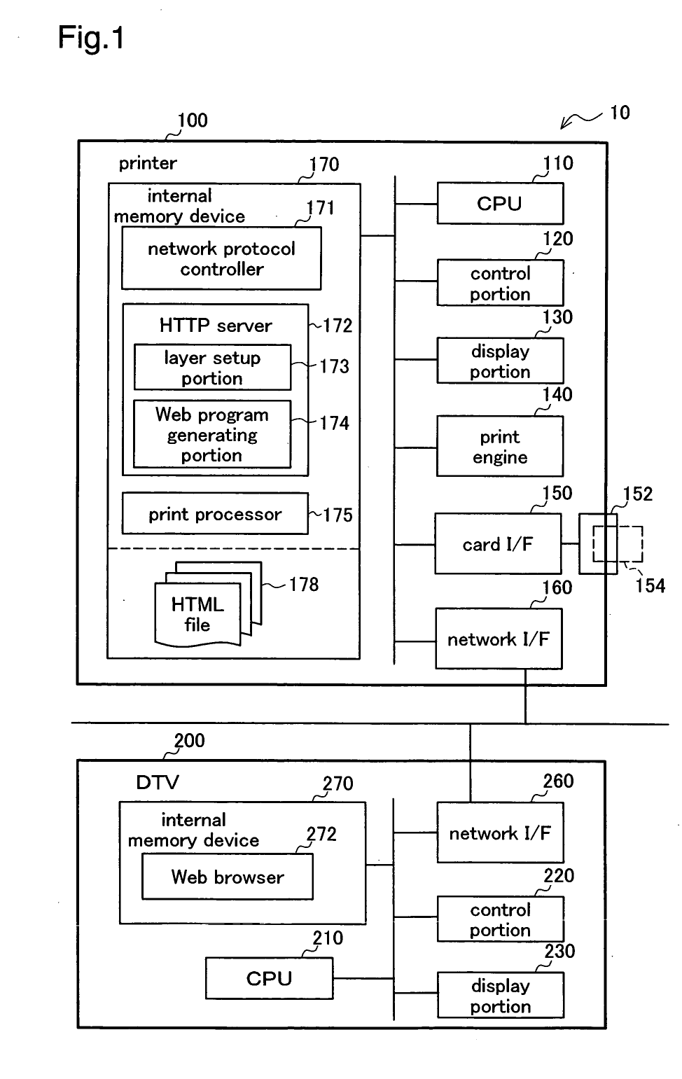

FIG. 1 is a block diagram showing schematically the configuration of a network system in the embodiment of the invention. This network system 10 has a configuration in which a printer 100 and a digital TV (hereinafter “DTV”) 200 are connected to one another via a LAN. The LAN may be a wired network such as IEEE 802.3, or a wireless network such as IEEE 802.11 b/g/a or the like.

The printer 100 and the DTV 200 are both network devices compliant with Universal Plug and Play (hereinafter “UPnP”; UPnP is a trademark of UPnP Implementers Corporation). Here, UPnP is an architecture whereby network devices can be connected to a network or disconnected from a network at any time. A UPnP network is composed of a control point and a device. A “device” refers to a device that provides a service. Herein the terms “device” and “service device” are used as synonyms unless indicated otherwise. A “control point” refers to a controller that discovers and controls other devices on the network, and functions as a client for service devices. Here, architecture whereby plug-and-play can be achieved in a network shall be termed “network-type plug-and-play.”

The printer 100 functions as a service device on the UPnP network, and provides image printing service to a control point. The printer 100 comprises a CPU 110, a control portion 120 such as buttons or a touch panel, a display portion 130 such as a liquid crystal monitor, a printer engine 140, a card interface (card I/F) 150, a network interface (network I/F) 160, and an internal memory device 170 such as ROM or RAM.

The printer engine 140 is a printing mechanism for carrying out printing on the basis of print data. The card interface 150 is an interface for exchange of data with a memory cared 154 inserted into a card slot 152. The network interface 160 has the function of mediating messages and data exchanged with other devices on the network.

The internal memory device 170 of the printer 100 stores computer programs that operate on a predetermined operating system, namely, a network protocol controller 171, an HTTP server program (hereinafter “HTTP server”) 172, and a printing processor 175. The HTTP server 172 includes a layer setup portion 173 and a Web program generating portion 174. The internal memory device 170 also stores HTML files 178.

The network protocol controller 171 is a program for carrying out mediation of messages and data with other devices on the network system in accordance with UPnP protocol or some other protocol. The HTTP server 172 is a program that replies with an HTML file 178 or the like in response to request from a Web browser or other client. The layer setup portion 173 is a program module for setting up layers that are elements included in HTML files, described later. The Web program generating portion 174 is a program module for generating a Web program (e.g. JavaScript) to operate on a client. The printing processor 175 is a program for controlling the printer engine 140 and carrying out printing of images based on image data stored in the memory card 154. The CPU 110 performs a network setting process, described later, by means of loading and executing these programs. The CPU 110 and the HTTP server 172 function as the Web service provider in the present invention. The HTTP server 172 is also termed a Web server or WWW server.

The DTV 200 functions as the control point in the UPnP network. In the embodiment, the DTV 200 functions as a client of the printer 100 as the service device. The DTV 200 comprises a CPU 210, a control portion 220 such as buttons or a remote control and remote control receiver, a display portion 230 such as a liquid crystal monitor, a network interface (network I/F) 260, and an internal memory device 270 such as ROM or RAM. The network interface 260 has the function of mediating messages and data exchanged with other devices on the network.

The internal memory device 270 of the DTV 200 stores a Web browser program (hereinafter “Web browser”) 272, which is a computer program that operates on a predetermined operating system. The Web browser 272 is a program for receiving an HTML file, parsing the received HTML file, and displaying on the display portion 230 a picture corresponding to the HTML file. The CPU 210 loads and executes the Web browser 272 from the internal memory device 270 in order to carry out the network setting process, described below.

UPnP implements the various types of processing described below using various protocols, such as HTTPMU, HTTPU, SOAP/HTTP and HTTP.

(1) Addressing: When a UPnP device (hereinafter referred to simply as a ‘device’) is connected to a network, the device obtains a network address (IP address) via addressing. The DHCP server or Auto-IP is used for addressing. Where the network has a DHCP server, the device uses the IP address assigned by the DHCP server. When there is no DHCP server, the device determines its own address using an automatic IP addressing function called Auto-IP.

(2) Discovery: Discovery is processing performed by the control point to locate a device. Discovery can be implemented by the control point multi-casting a discovery message, or by the device advertising to the control point that it has joined the network. Discovery is carried out using HTTPMU/SSDP or HTTPU/SSDP. As a result of discovery, the control point and the device are enabled to proceed with processing on a peer-to-peer basis.

(3) Description: Device structure details are described as a device description using XML. Device service details are described as a service description using XML. These descriptions are owned by the device and are provided to the control point. The control point can learn the device and service details by referring to these descriptions.

(4) Control: Control is a processing performed by the control point to control the device by forwarding to the device a control message including an action request. Control is performed using HTTP/SOAP.

(5) Event: When a prescribed event occurs, a service in the device notifies the control point of such event. The control point that wishes to receive notification of the event ‘subscribes’ to that service. The event is forwarded to the control point that has subscribed. Notification of an event is performed using HTTP/GENA.

(6) Presentation: Presentation is processing performed by the control point to obtain a presentation page described using HTML from a presentation URL registered in the device description. Via this presentation, the control point can display the various states of the device, for example.

The present invention can be applied to future versions of UPnP. In addition, the present invention can also be applied to network-type plug-and-play specifications other than UPnP if the network-type plug-and-play specification provides an architecture in which a control point and a device can communicate with each other on a peer-to-peer basis via addressing (automatic IP address determination) and device discovery to enable the control point and the device to exchange messages.

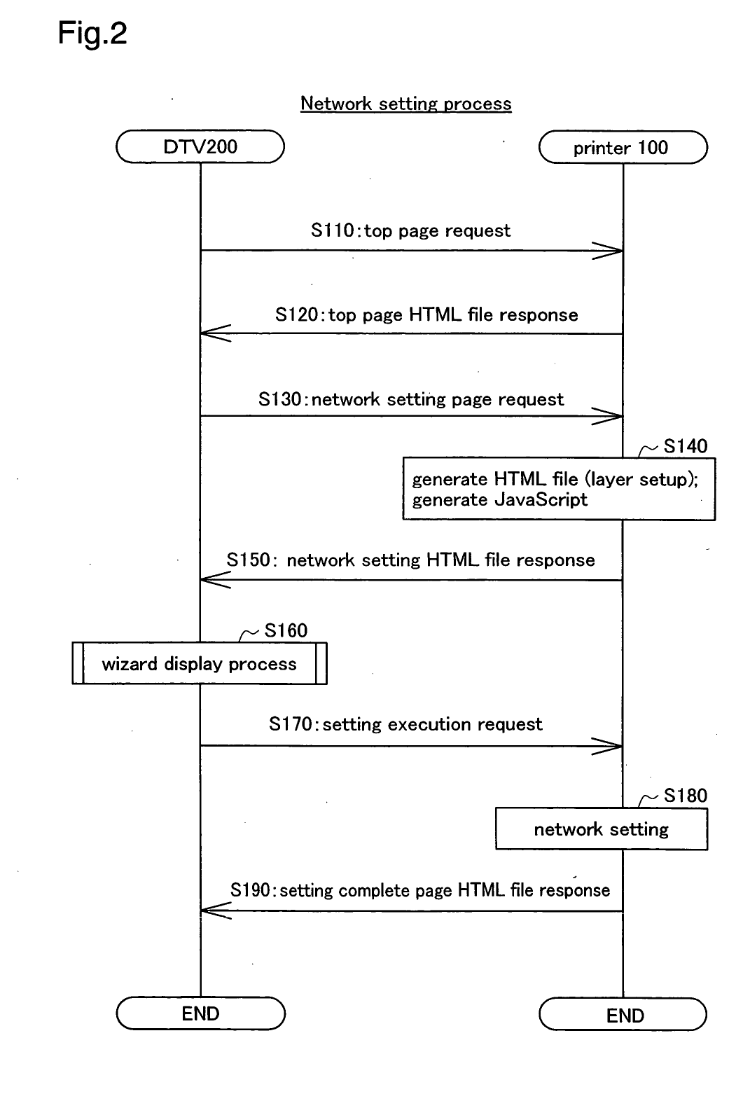

FIG. 2 is a flowchart showing the flows of the network setting process in the network system 10 of the embodiment. The network setting process of the embodiment is a process whereby pictures in wizard format for specifying network setting to be made for the printer 100 are displayed on the display portion 230 of the DTV 200, and network setting for the printer 100 is made in accordance with instructions by the user made through the control portion 220. Here, a wizard refers to a function for displaying a sequentially switched series of multiple pictures, while enabling the user to specify, in dialog format, execution of a predetermined task such as making network setting. Wizard format pictures refer to a series of multiple pictures in dialog format displayed sequentially as the user navigates through the instruction procedure for the predetermined task. Network setting for the printer 100 refers to setting the network setting items, such as the IP address, subnet mask and the like of the printer 100 on the network system 10.

It is assumed that, in the network system 10 (FIG. 1) prior to initiation of the network setting process of the embodiment, the printer 100 and the DTV 200 have both joined the network system 10, and through UPnP addressing, discovery and so on have completed the process of making their own network setting and are in a state of being able to communicate with one another. That is, the network setting process of the embodiment is a process for updating network setting for the printer 100. The DTV 200 is assumed to recognize the device configuration and service content of the device, i.e. the printer 100, through the description step of UPnP.

In Step S110 (FIG. 2), the Web browser 272 of the DTV 200 (FIG. 1) requests the top page of the printer 100. This process is executed, for example, in response to an operation requesting the printer top page, made by the user through the control portion 220 of the DTV 200. In the embodiment, the top page of the printer 100 is a page for presentation in UPnP, and the URL of the page is registered in the device description of the printer 100. The Web browser 272 requests the presentation URL registered in the device description.

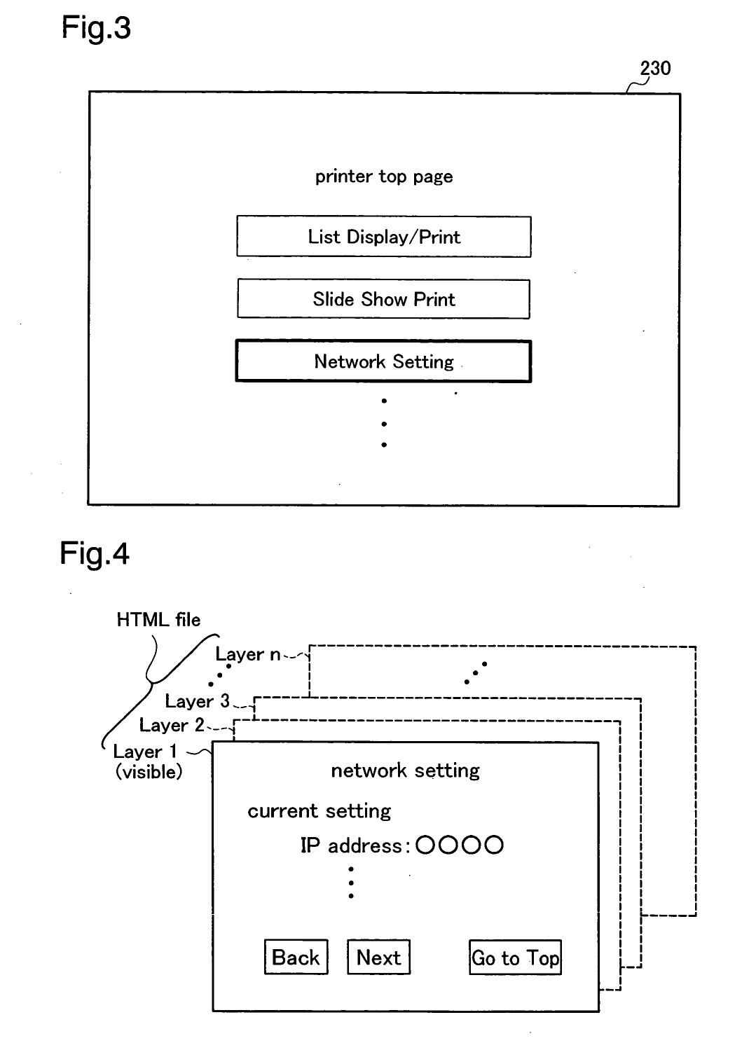

In Step S120 (FIG. 2), the HTTP server 172 of the printer 100 (FIG. 1), in response to the request from the DTV 200 in Step S110, replies with the HTML file 178 of the printer top page. By so doing, the printer top page is displayed on the display portion 230 of the DTV 200 (FIG. 1). FIG. 3 is a diagram showing an example of the printer top page. As shown in FIG. 3, the printer top page includes buttons allowing the user to select various services provided by the printer 100.

In the embodiment, the services provided to the DTV 200 by the printer 100 include, in addition to image printing services namely, List Display/Print and Slide Show Print, a service for making network setting for the printer 100 itself.

In Step S130 (FIG. 2), the Web browser 272 of the DTV 200 (FIG. 1) requests the page for making network setting. This process is executed in response to the user selecting the “Network Setting” button from the printer top page shown in FIG. 3.

In Step S140 (FIG. 2), the HTTP server 172 of the printer 100 generates an HTML file for performing network setting. FIG. 4 is a diagram showing in a conceptual fashion the network setting HTML file used in the embodiment. As shown in FIG. 4, the network setting HTML file used in the embodiment contains multiple layers. Here, a layer is one element of a Web page described as an HTML file, and is defined using a tag. Elements such as text and images (these are also called “objects”) can be positioned on a layer.

As shown in FIG. 4, in the embodiment n layers corresponding to pictures in wizard format for specifying network settings, i.e. n pictures in dialog format to be sequentially displayed while navigating through the instruction procedure are established in the network setting HTML file by the layer setup portion 173 of the HTTP server 172 (FIG. 1).

In addition to attributes defining size, position, and so on, layers also have an attribute defining whether or not the layer will be displayed on the client (DTV 200) (hereinafter termed the “visibility attribute”). Where the visibility attribute of a layer has been set to “Show” the layer will be displayed on the client, whereas if the visibility attribute of a layer has been set to “Hide” the layer will not be displayed on the client. Herein, a layer whose visibility attribute is set to “Show” is termed a “visible layer,” and a layer whose visibility attribute is set to “Hide” is termed a “hidden layer.” At the point in time that the layers are established, only the layer which corresponds to the first picture (Layer 1) of the network setting HTML file is set as a visible layer, with the other layers (Layers 2 to n) being set to hidden layers.

In Step S140 (FIG. 2), the Web program generating portion 174 of the HTTP server 172 (FIG. 1) generates a JavaScript for use as a Web program to operate on the client. This JavaScript is a program for making the client (the Web browser 272 of the DTV 200) implement a first function for setting and modifying the visibility attribute of the layers, thereby sequentially switching pictures for specifying network setting; and a second function for compiling values input by the user during display of the pictures and instructing the printer 100 to execute a predetermined task according to these input values. In the embodiment, the first function is a function for setting/modifying the visibility attribute of layers so that at any given time only one of the n layers included in the network setting HTML file is set as a visible layer, while the other layers are set as hidden layers. The JavaScript saves, in the form of a cookie, information identifying the one layer to be set as the visible layer.

Switching display picture by means of the first function described above is executed in accordance with associating information pre-established for the series of n pictures. This associating information is information defining a picture display sequence for creating a wizard function, and defines, for example, which picture should be displayed next after a given picture. The associating information is defined according to values input by the user (including selected values) during picture display; where a user has input a given value, the picture displayed subsequently may differ from the picture displayed subsequently if a different value had been input, for example.

The JavaScript created in Step S140 is embedded in the network setting HTML file. The network setting HTML file and the JavaScript need not necessarily be generated during the network setting process (FIG. 2), but could instead be generated in advance and stored by the printer 100.

In Step S150 (FIG. 2), the HTTP server 172 of the printer 100 (FIG. 1) replies to the Web browser 272 of the DTV 200 with the network setting HTML file. Since the JavaScript created in Step S140 has been embedded in the network setting HTML file, the JavaScript will be transmitted to the Web browser 272 as well.

Having received the network setting HTML file, the Web browser 272 of the DTV 200 (FIG. 1) now executes the process beginning with Step S160 (FIG. 2), while utilizing the first function and the second function described above implemented by means of the JavaScript embedded in the network setting HTML file.

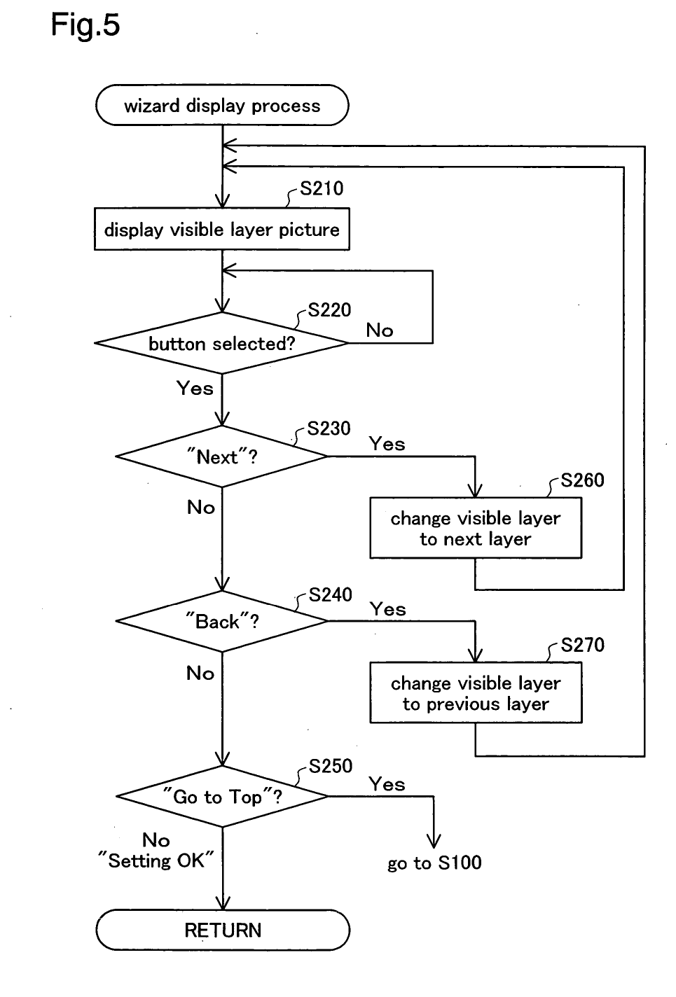

In Step S160 (FIG. 2), the Web browser 272 of the DTV 200 interprets the network setting HTML file and carries out the wizard display process. FIG. 5 is a flowchart showing the flows of the wizard display process in the network system 10 of the embodiment. The wizard display process of the embodiment is a process for displaying on the display portion 230 of the DTV 200 a series of pictures in wizard format for specifying network setting for the printer 100. Specifically, it is a process enabling the user to specify network setting in dialog format, while sequentially switching a picture to be displayed among a series of n pictures corresponding to the n layers included in the network setting HTML file.

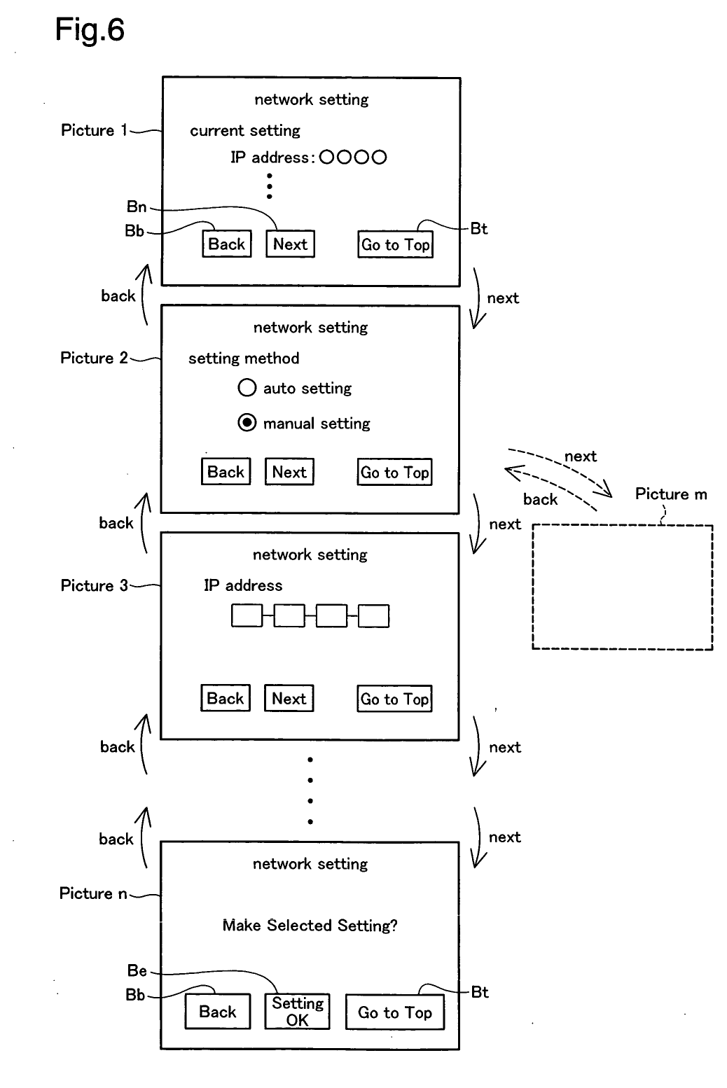

In Step S210 (FIG. 5), the Web browser 272 of the DTV 200 (FIG. 1), on the basis of the network setting HTML file, displays on the display portion 230 of the DTV 200 the picture corresponding to the visible layer. FIG. 6 is a diagram showing an example of display pictures in the wizard display process. As described above, at the point in time that the layers are established in Step S140 (FIG. 2), only the layer which corresponds to the first picture (Layer 1) of the network setting HTML file is set as the visible layer. Thus, in the stage at which the network setting HTML file is received by the Web browser 272, the picture corresponding to Layer 1 (Picture 1) shown at the top in FIG. 6 will be displayed on the display portion 230, while pictures corresponding to the other layers (Layers 2-n) are not displayed.

As shown in FIG. 6, the picture corresponding to each layer includes a “Back” button Bb and a “Next” button Bn allowing the user to switch back and forth between pictures. Each picture also includes a “Go to Top” button Bt that allows the user to switch the picture back to the printer top page (FIG. 3). The picture n corresponding to Layer n, shown at the bottom in FIG. 6, includes in place of the “Next” button Bn a “Setting OK” button Be for the user to instruct that final network setting be made.

In Step S220 (FIG. 5), the Web browser 272 decides whether or not the user has selected any of the buttons that are included in the display picture. The decision in Step S220 is executed repeatedly until it is decided that a button has been selected.

In the event of a decision in Step S220 that a button has been selected, the Web browser 272 then determines which button has been selected. In the event the Web browser 272 determines that the selected button is the “Next” button Bb (Step S230: Yes), the Web browser 272 identifies the current visible layer by means of the cookie, and modifies the layer visibility attribute so that the visible layer is changed to the layer corresponding to the next succeeding picture (Step S260). The new visible layer is registered in a cookie.

Here, “next succeeding picture” refers to the picture that, according to the associating information described previously, has been established as the picture to be displayed next after the picture corresponding to the current visible layer. For example, where the visible layer has been set to Layer 1 and Picture 1 (FIG. 6) is currently displayed on the display portion 230 of the DTV 200, the Web browser 272 will change the visibility attribute of Layer 2 corresponding to Picture 2, which is the “next succeeding picture,” from “hidden” to “visible,” and will change the visibility attribute of Layer 1 from “visible” to “hidden.”

As noted previously, the associating information is defined according to values input by the user (including selected values) during picture display. Thus, in some instances the aforementioned “next succeeding picture” may differ depending on user input values. For example, in the example of FIG. 6, in the event that the user selects “Manual Setting” in Picture 2 and then selects the “Next” button Bb, Picture 3 will now become the “next succeeding picture,” and the layer corresponding to Picture 3 (Layer 3) will be set as the new visible layer. On the other hand, in the event that the user selects “Auto Setting” in Picture 2 and then selects the “Next” button Bb, Picture m will now become the “next succeeding picture,” and the layer corresponding to Picture m (Layer m) will be set as the new visible layer.

Subsequently, the process returns to Step S210 (FIG. 5), and the Web browser 272 now displays the picture corresponding to the new visible layer on the display portion 230 of the DTV 200.

In the event that the Web browser 272 determines that the selected button is the “Back” button Bb (Step S240: Yes in FIG. 5), the Web browser 272 identifies the current visible layer by means of the cookie, and modifies the layer visibility attribute so that the visible layer is changed to the layer corresponding to the previous picture (Step S270). The new visible layer is registered in a cookie. Here, “previous picture” refers to the picture that, according to the associating information described above, has been established as the picture to be displayed before the picture corresponding to the current visible layer. For example, where the visible layer has been set to Layer 2 and Picture 2 (FIG. 6) is currently displayed on the display portion 230 of the DTV 200, the Web browser 272 will change the visibility attribute of Layer 1 corresponding to Picture 1, which is the “previous picture,” from “hidden” to “visible,” and will change the visibility attribute of Layer 2 from “visible” to “hidden.” Subsequently, the process returns to Step S210 (FIG. 5), and the Web browser 272 now displays the picture corresponding to the new visible layer on the display portion 230 of the DTV 200. By means of this process, it is possible to switch back to a previous picture while navigating through the network setting instruction procedure.

In this way, the wizard display process involves switching the display picture among a series of n pictures for realizing a wizard function to carry out network setting for the printer 100. During picture display, the user inputs or selects the network setting through the control portion 220 of the DTV 200.

In the event of a determination that the selected button is the “Go to Top” button Bt (Step S250: Yes in FIG. 5), the process returns to Step S110 (FIG. 2), and the Web browser 272 again issues a request for the top page of the printer 100.

When Picture n corresponding to Layer n, shown at the bottom in FIG. 6, is displayed, in the event that the Web browser 272 decides that the “Setting OK ” button Bn instructing that final network setting be made has been selected (Step S250: No in FIG. 5), the process advances to Step S170 of FIG. 2.

In Step S170 (FIG. 2), the Web browser 272 of the DTV 200 issues a request to the HTTP server 172 of the printer 100 to instruct making of network setting for the printer 100. This request to make network setting includes the network setting execution URL for making the HTTP server 172 of the printer 100 which received the request boot the network protocol controller 171 (FIG. 1) that executes the network setting. The Web browser 272 compiles values input or selected by the user during the wizard display process (FIG. 5), generates information identifying specific network setting depending on these values, and adds this information to a cookie. This cookie is appended to the request to execute network setting. By so doing, specific network setting is identified, and the specific setting is transmitted to the printer 100.

In Step S180 (FIG. 2), the HTTP server 172 of the printer 100 boots the network protocol controller 171 (FIG. 1), and executes the specific network setting specified by the specific network setting information contained in the cookie. In the embodiment, when executing network setting, the network protocol controller 171 functions as a CGI (Common Gateway Interface) program.

In Step S190 (FIG. 2), the HTTP server 172 of the printer 100 responds to the Web browser 272 of the DTV 200 with the HTML file 178 of a Setting Complete page showing that network setting have been completed. By so doing, the page indicating that network setting has been completed is displayed on the display portion 230 of the DTV 200.

As described above, in the network setting process of the embodiment, there is executed a wizard display process that displays on the DTV 200 a series of pictures in wizard format for specifying network setting for the printer 100, and that in dialog format prompts the user to specify these network setting. This wizard display process employs a network setting HTML file that includes a plurality of layers corresponding respectively to a series of a plurality of pictures of dialog format displayed sequentially as the one navigates through the procedure for specifying network setting. Switching a display picture among a multiple pictures is accomplished by means of modifying the visibility attribute of the layers included in the network setting HTML file. Thus, switching a display picture need not involve any communication, such as sending HTML files back and forth, between the HTTP server 172 and the Web browser 272. Consequently, in the network setting process of the embodiment, it is possible to reduce the load on the HTTP server 172 and the Web browser 272 associated with switching a display picture, and to accelerate processing as well as to improve user-friendliness. This benefit is particularly important in cases where the Web browser 272 of the DTV 200 lacks a cache function or other cases where the DTV 200 has a low level of functionality or capability.

### B. Variations

The present invention is not limited to the embodiment and the aspect described above. The present invention may be worked in various aspects within limits that involve no departure from the spirit of the invention; for example, the following variations are possible.

B1. Variation 1

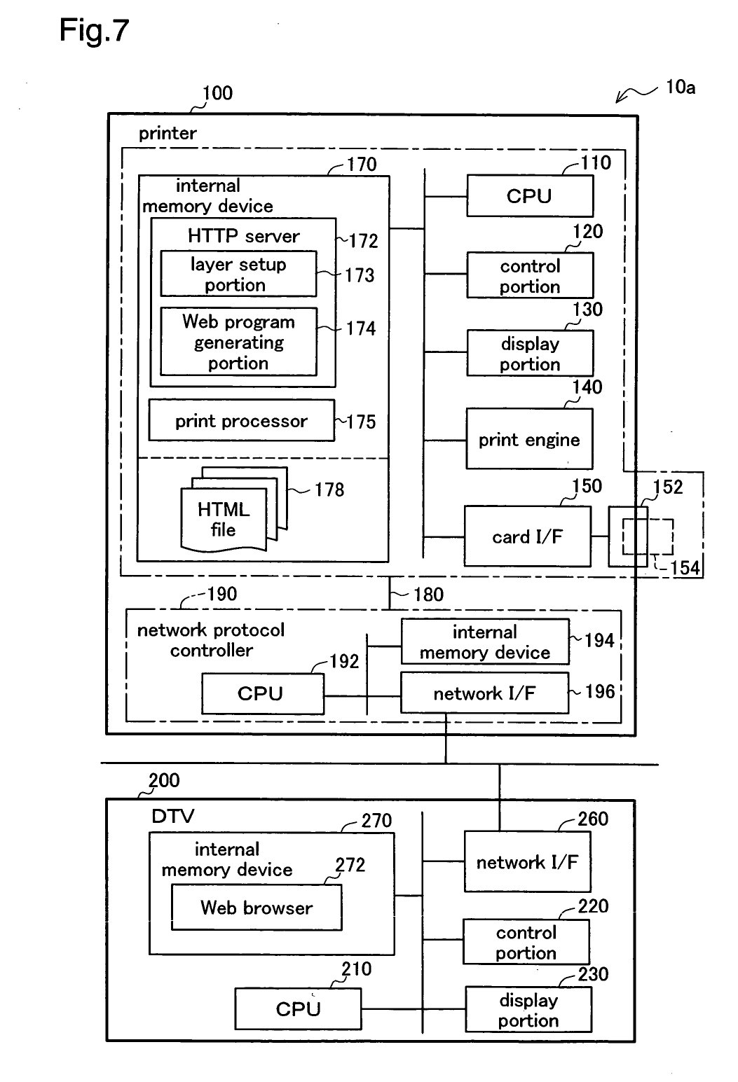

The configuration of the network system 10 in the embodiment is merely exemplary, and other configurations for the network system 10 are possible also. FIG. 7 is a block diagram showing schematically the configuration of a network system in the variation. The network system 10a of the variation depicted in FIG. 7 differs from the preceding embodiment in that the printer 100 has an independent arrangement for the network protocol controller 190. The network protocol controller 190 of the printer 100 in the network system 10a of the variation includes a CPU 192, an internal memory device 194 such as ROM or RAM, and a network interface 196; and the network protocol controller 190 has functions equivalent to the CPU 110, network protocol controller 171, and network interface 160 in the embodiment. In the printer 100, the network protocol controller 190 is connected with the remaining components by means of a USB 180, for example. By adopting the configuration depicted in FIG. 7 for the printer 100, it is possible to split the portion that carries out control of protocol in UPnP from the portion that functions as a service device, affording improved flexibility in design.

In the embodiment, the printer 100 has a network protocol controller 171 and is UPnP-compliant; however, it is possible for the invention to be implemented in a non-UPnP-compliant printer that lacks a network protocol controller 171. The invention is implementable in network devices other than a printer 100, as long as the device is furnished with HTTP server 172 functionality.

In the embodiment, the example of a DTV 200 as the client device was described, but it is possible for the invention to be implemented in client devices other than a DTV 200 (e.g. a mobile phone) as long as the device is furnished with Web browser 272 functionality.

B2. Variation 2

In the embodiment, setting and modification of the visibility attribute of the layers by means JavaScript is accomplished by setting only one of the plurality of layers included in the network setting HTML file as the visible layer, while setting the other layers as hidden layers; however, it is not necessary to do so in all instances. Setting of the layer visibility attribute could also be carried out by setting multiple layers as visible layers. In this case, switching a display picture can be accomplished by setting and modification of an attribute representing overlap of layers.

B3. Variation 3

While the embodiment describes an example wherein JavaScript is the Web program that operates on the client, the Web program operates on the client could instead be some other program, for example, a VB Script. While in the embodiment the Web program (e.g. JavaScript) is embedded in the network setting HTML file, it is not necessary in all instances for the Web program to be embedded in the network setting HTML file, it being acceptable to append the Web program to the network setting HTML file sent in reply to the Web browser 272. Also, whereas the embodiment described the example of HTML as the markup language, it would be possible to use some other markup language as the markup language.

While in the embodiment hereinabove, the JavaScript uses a cookie to identify the one layer set as the visible layer, identification of the visible layer could employ other information, for example, a unique JavaScript parameter. In the embodiment, while cookies are also used to identify specific network setting, specific network setting could instead be identified by some other method, for example, by including directly in the network setting execution URL information for identifying specific network setting.

B4. Variation 4

While the embodiment describes an example of a wizard display process during the network setting process, the invention is applicable to other processes as well, provided the process involves switching a display picture among multiple pictures making up a series.

B5. Variation 5

Some of the arrangements realized through hardware in the embodiment could instead be replaced by software; conversely, some of the arrangements realized through software could be replaced by hardware.

What is claimed is:

1. A network device comprising:
a Web service provider that, in order to cause a client in a network to display a series of multiple pictures, the client having a function as a Web browser, sends the client in response to a request from the client a markup language file described in a predetermined markup language,
wherein the markup language file includes as elements thereof a plurality of layers corresponding respectively to the series of multiple pictures, the layer having a visibility attribute that defines whether or not the layer will be displayed on the client, and
wherein the Web service provider includes a Web program generator that generates a Web program that operates on the client and appends the Web program to the markup language file, the Web program causing the client to implement a first function whereby the visibility attributes of the plurality of layers are modified to switch the picture displayed on the client without communicating with the Web service provider.

2. A network device according to claim 1, wherein
the series of multiple pictures are pictures that allow a user to instruct a predetermined task in dialog format, and
the Web program is a program for causing the client to implement a second function whereby values input by the user during display of the series of multiple pictures are compiled and the network device is instructed to execute the predetermined task according to the input values.

3. A network device according to claim 1, further comprising:
a network protocol controller that controls message exchange between the client and the Web service provider in accordance with a network-type plug-and-play protocol.

4. A network device according to claim 2, further comprising:
a network protocol controller that controls message exchange between the client and the Web service provider in accordance with a network-type plug-and-play protocol.
